(19) United States
(12) Patent Application Publication
(10) Pub. No.: US 2001/0008676 A1
(43) Pub. Date: Jul. 19, 2001

(54) STRETCHABLE FILM HAVING ELONGATED APERTURES

(76) Inventors: JAMES E. PELKIE, TERRE HAUTE, IN (US); GREGORY M. RIEKER, CLINTON, IN (US)

Correspondence Address: ROBERT A MCFALL, 1445 ROSS AVENUE, SUITE 3200, DALLAS, TX, 752022799

(21) Appl. No.: 09/103,951

(22) Filed: Jun. 24, 1998

(51) Int. Cl. B32B 3/10

(52) U.S. Cl. 428/136

(57) ABSTRACT

Elongated apertures each having a major axis and a minor axis, are formed in a stretchable film having a predefined direction of stretch. The apertures are oriented in the film with the major axes of the apertures disposed perpendicular to the predefined direction of stretch. The apertures are also disposed in the film with greater separation between the apertures in the direction parallel to the major axes of the apertures than the separation between adjacently disposed apertures in a direction parallel to the minor axes of the apertures. The elongated openings, when positioned with the major axes perpendicular to a predefined direction of stretch, has better breathability and elastic properties than comparable symmetric aperture shapes when both are subjected to cross direction elongation.

### BACKGROUND OF THE INVENTION

1. Technical Field

This invention relates generally to an apertured film product, and more particularly to an apertured elastomeric film that is stretchable in a predefined direction.

2. History of Related Art

Apertured elastomeric films are commonly used to impart elastic properties and breathability to personal hygiene articles, such as diapers, adult incontinence products, feminine hygiene products, medical wraps and the like. When an apertured film is stretched, the individual holes, or apertures, tend to collapse, and the amount of air or fluid that can pass through the film is reduced. A symmetrical hole will tend to collapse due to film necking-in across the direction of stretch. As a result, apertured films having a symmetrical hole shapes have a reduced open area when stretched. This characteristic restricts the transfer of moisture or liquid through the film, thereby reducing the effectiveness and comfort of the personal hygiene article.

Furthermore, apertured films having symmetrical hole shapes and pattern, i.e., equally spaced apart symmetrical openings, have the same cross-sectional area in all directions of stretch. Thus, the change in elastic properties, due to the presence of apertures in the film, are omni-directional, that is, the change in elastic properties in the direction of stretch attributable to the apertures are not any better than the change in elastic properties of the film resulting from the apertures in any other direction of stretch.

The present invention is directed to overcoming the problems set forth above. It is desirable to have an apertured elastomeric film that can be stretched in a predefined direction which maintain better breathability, i.e., porosity, under elongation than symmetrically shaped holes or non-symmetrically shaped holes that do not have a short access aligned with the predefined direction of stretch. It is also desirable to have an apertured film, suitable for use in personal hygiene articles, that provides higher extension, and better elastic performance in the direction of stretch, than a film having a symmetrical pattern, while maintaining comparable open area in a relaxed state and less loss of open area in an elongated state.

### SUMMARY OF THE INVENTION

In one aspect of the present invention, an apertured elastomeric film that is stretchable in a predefined direction, has a plurality of elongated apertures which have a major axis extending along the length of the respective aperture, and a minor axis transversely disposed with respect to the respective major axis. The major axis of each of the elongated apertures is orthogonally oriented with respect to the predefined direction of stretch.

Other features of the apertured elastomeric film embodying the present invention, include the film having a porosity, as measured by the flow rate of air through the film per unit area, when a 50% strain is applied to the film in the predefined direction of the stretch, that is at least 70% of the porosity of the film when in a relaxed state.

Other features of the apertured elastomeric film include the ratio of the length of the major axis to the length of the minor axis of each of the apertures being from about 1.5:1 to about 5.0:1. Additional features include the spacing between the apertures, in a direction parallel to the major axis of the apertures being less than the length of the major axis, and the spacing between apertures in a direction parallel to the minor axis of the apertures, being less than the length of the minor axis.

Yet other features of the apertured elastomeric film embodying the present invention include the spacing between the apertures, in a direction parallel to the major axes of the apertures, being from about 1.5 to about 5 times the spacing between the apertures in a direction parallel to the minor axes of the apertures.

In another aspect of the present invention, an apertured elastomeric film that is stretchable in a defined direction and has a plurality of elongated apertures extending through the film, has a porosity as measured by the flow rate of air through the film per unit area, when a 50% strain is applied to the film in a predefined direction of stretch, of at least 70% of the porosity of the film when in a relaxed state.

Other features of the apertured elastomeric film include each of the apertures having a major axis extending along the length of a respective aperture and a minor axis transversely disposed with respect to the major axis, wherein the major axis of each of the elongated apertures is orthogonally oriented with respect to the predefined direction of stretch.

### BRIEF DESCRIPTION OF THE DRAWINGS

A more complete understanding of the structure and operation of the present invention may be had by reference to the following detailed description when taken in conjunction with the accompanying drawings, wherein:

FIG. 1 is a plan view of a stretchable apertured film embodying the present invention, with a portion of the apertures shown in enlarged detail for clarity;

FIG. 2 is a schematic representation an illustrative embodiment of a hole pattern embodying the present invention;

FIG. 3 is a schematic representation of another illustrative embodiment of another hole pattern embodying the present invention; and

FIG. 4 is a schematic representation of still another illustrative embodiment of yet another hole pattern embodying the present invention.

### DETAILED DESCRIPTION OF PRESENTLY PREFERRED EXEMPLARY EMBODIMENTS

Apertured elastomeric films are commonly used to provide transmission of moisture and fluid, for example between an area adjacent a skin surface and an absorptive layer, in personal hygiene articles such as diapers, adult incontinence products, and feminine hygiene products. The elastomeric films in such products, may be stretched from about 50% to about 200% during use in disposable articles such as diapers. Heretofore, there has been a significant loss in the porosity of the apertured film when stretched, due to collapse of the holes and necking-in across the direction of stretch, and the resultant loss in open area.

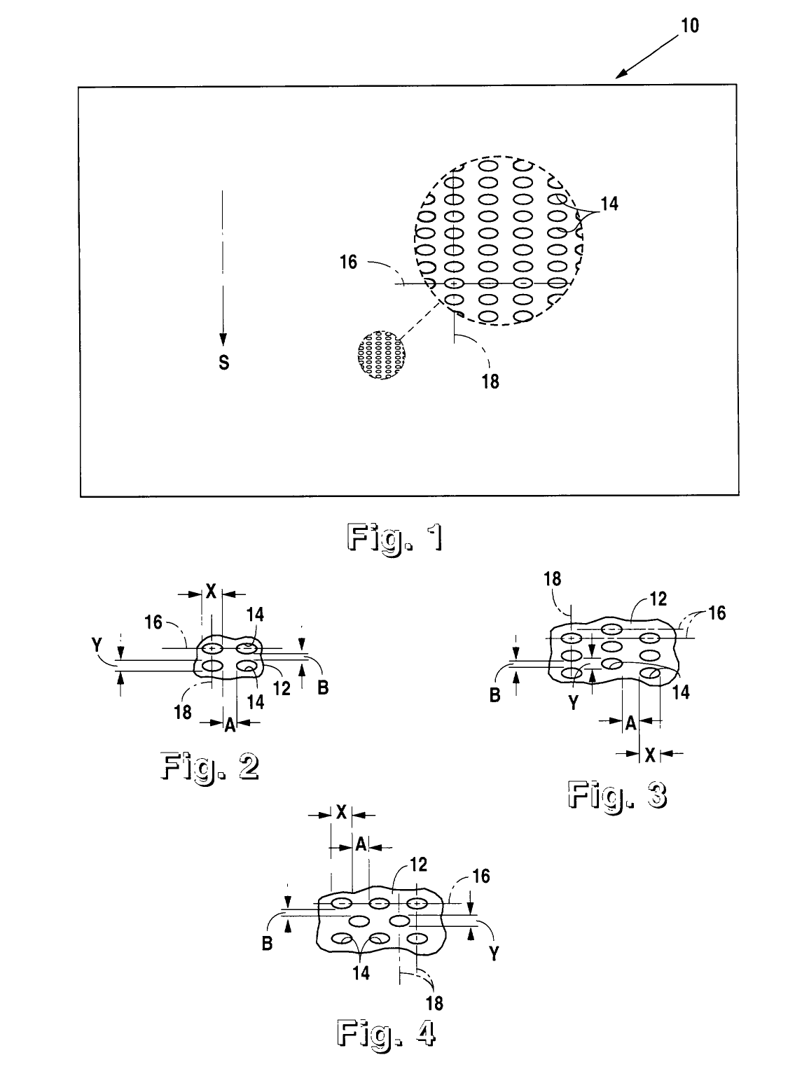

In the preferred embodiment of the present invention, as shown in FIG. 1, an apertured elastomeric film 10, has the plurality of elongated apertures 14 formed therethrough. Preferably, the elastomeric film 10 is formed of a thermoplastic material in which the apertures 14 are produced by vacuum forming, hydroforming, or other method in which the film is simultaneously perforated and shaped. For example, a method of producing a perforated film is described in U.S. Pat. No. 5,718,928, issued Feb. 7, 1998, titled “Screen For Producing A Perforated Film”, to Gregory M. Rieker, a co-inventor of the invention described herein and assigned to the assignee of the present invention. While any one of several thermoplastic materials may be used to form the initial base structure for the apertured film 10 embodying the present invention, in practice it has been found that polyolefin materials and other thermoplastic elastomeric materials including styrene block copolymers, polyurethane, ethylene vinyl acetate, and the like, work particularly well in forming the stretchable apertured film with specifically aligned elongated openings in accordance with the present invention.

As best illustrated in FIGS. 2-4, each of the apertures 14 have a major axis 16, extending along the length of the aperture, and a minor axis 18 extending across the width of each of the apertures 14. In FIGS. 2-4 and in the tables presented below, the length of the major axis 16 of each of the apertures 14 is designated by the letter X, and the length of the minor axis 18 of each aperture 14 is designated by the letter Y. Major-to-minor axis ratios, i.e., ratios of X:Y, of from about 1.5:1 to about 5:1 are preferred to achieve the desired performance with elastomeric films that are stretched 50% to 200% in a predefined direction S, as indicated in FIG. 1, during use in disposable articles such as diapers. Importantly, the major axis 16 of each of the apertures 14 is orthogonally oriented with respect to the predefined direction of stretch S, i.e., the minor axis 18 of each of the apertures is aligned parallel to the predefined direction of stretch S.

Also, as illustrated in FIGS. 2-4, the separation between the apertures 14 in the direction of the major axis 16 is designated as dimension A, and the dimension separating the apertures 14 in the direction of the minor axis 18 is designated by the letter B. Ratios of from about 1.5:1 to about 5:1 are preferred for the respective separation distances between holes 14 in the respective directions along the major 16 and minor axis 18.

The orientation of the elongated openings 14, with respect to a predefined direction of stress S, is extremely important in carrying out the present invention. With the minor axis 18 of the apertures 14 oriented parallel with the direction of stress S, when a tensile force is applied in a predefined direction S, the elongated openings 14 tend to assume a more symmetric shape. For example, an oval shape tends to become circular when the film 10 is stretched in a direction perpendicular to the major axis 16. This characteristic is important in reducing the loss of porosity as a tensile force is applied in the predefined direction of stretch S.

As listed in Table I, eight different films were vacuum formed and tested in accordance with ASTM D-737. The aperture sizes and open areas, as measured on the screen on which the films were formed, is listed below in Table I. The actual aperture size and open area of the test films was slightly less than the listed dimensions and open area percentages of the measured screens, due to the thickness of the formed films (about 0.003″). However, it is believed that the dimensional and open area properties are substantially equally reduced for all the samples and the resultant porosity properties equally affected.

TABLE I

| | RATIO X:Y | | | | |
|---|---|---|---|---|---|
| PARAMETER | 2:1 | 3:2 | 3:1 | 4:1 | 5:1 |
| X axis length (mm) | 0.76 | 0.76 | 2.29 | 2.03 | 2.54 |
| Y axis width (mm) | 0.38 | 0.51 | 0.76 | 0.51 | 0.51 |
| A land length (mm) | 0.63 | 0.63 | 1.52 | 2.29 | 1.78 |
| B land width (mm) | 0.32 | 0.32 | 0.38 | 0.32 | 0.33 |
| Screen open area | 23% | 26% | 31% | 23% | 29% |

Square holes (in a 90° array)

62 holes per square area

X axis length 0.63 mm

Y axis width 0.63 mm

A land length 0.63 mm

B land width 0.63 mm

Screen open areas 25 %

Circular holes (in a 60° array)

112 holes per square cm

hole diameter 0.58 mm

Screen open area 30%

Hexagonal holes (in a 60° array)

13.6 holes per square cm

Long axis 1.75 mm

Across flats 1.52 mm

Screen open area 27%

Table II, below, demonstrates the effect of hole shape on the porosity of variously-shaped apertured elastic films, when subjected to varying amounts of tensile strain, i.e., stretch, a direction perpendicular to the major axes of the openings. Air flow was repeatedly measured across a 1.5 inch diameter sample of each of the films identified in Table I. The square and round holes are geometrically symmetrical in shape opening, whereas the hexagonal holes have an axis that is somewhat longer than the distance across the flats of the hexagonal shape. Five different oval-shaped elongated apertures were tested, having X:Y ratios from 2:1 to 5:1.

As shown in Table II, the air flow through each test sample when the sample was in a relaxed state, i.e., 0% elongation, was considered to be the 100% base for the subsequently measured air flow as the test sample was stretched to 100% elongation in a direction perpendicular to the major axes 16 of the elongated openings, in a direction perpendicular to the sides of the square openings, and diametrically with respect to the round-shaped apertures. Porosity is defined as the volume of air flow per minute per unit area at a pressure drop of 0.5 inches (1.27 cm) of water. As can be seen from the test results, the square, round, and substantially symmetrical hexagonally-shaped apertures exhibited a measurable decrease in porosity at just 10% elongation, and porosity dropped significantly as elongation increased to 50% whereat the test of those samples was discontinued. In marked contrast, the porosity of the elongated holes oriented with the major axis 16 perpendicular to the direction of elongation, showed a significant increase under 10% elongation. Moreover, the apertures having a 3:1 to 5:1 ratio of major to minor axes (X:Y) not only showed an immediate increase in porosity under 10% elongation, but exhibited better porosity from 10% to 100% elongation than in the relaxed state (0% elongation). Significantly, the apertures having a 3:1 ratio of major to minor axes had double the initial porosity at 40% to 50% elongation, and almost double the porosity of the film in the relaxed state when stretched to 100% elongation.

TABLE II
Effect of Elongation on Porosity of Films with Various Hole Patterns

| Hole | ELONGATION | | | | | | | |
|---|---|---|---|---|---|---|---|---|
| Pattern | 0% | 10% | 20% | 30% | 40% | 50% | 75% | 100% |
| Square | 100% | 96% | 87% | 75% | 57% | 40% | — | — |
| Round | 100% | 93% | 82% | 72% | 52% | 47% | — | — |
| Hexagonal | 100% | 88% | 74% | 59% | 52% | 37% | — | — |
| 2:1 Oval | 100% | 104% | 96% | 88% | 83% | 77% | — | — |
| 3:2 Oval | 100% | 104% | 95% | 88% | 81% | 74% | — | — |
| 3:1 Oval | 100% | 123% | 149% | 179% | 200% | 203% | 193% | 186% |
| 4:1 Oval | 100% | 109% | 113% | 116% | 122% | 127% | 120% | 112% |
| 5:1 Oval | 100% | 110% | 117% | 120% | 124% | 122% | 117% | 115% |

The above test demonstrates that there is significantly improved porosity for an apertured film having elongated holes, where the strain is applied in a direction perpendicular to the major axis of the elongated openings, when compared to an apertured film having symmetric openings. Furthermore, although the elongated apertures 14 may have other shapes, such as elongated rectangles or other multi-sided shapes, elliptical holes are preferred because there are no discontinuities, i.e., corners, that initiate or propagate tears during stretch.

In addition to the porosity advantages provided by an elongated aperture oriented with the major axis 16 of the aperture 14 perpendicular with a predefined direction of stretch S, the pattern of the elongated apertures 14 through the film can be arranged to provide higher extension forces and better elastic performance than that provided by a symmetrical pattern. This is accomplished while providing comparable open area in a relaxed state, and less loss of open area when stretched. In the present invention, this advantage is provided by arranging the apertures 14 so that there is greater separation, i.e., spacing, between apertures 14 in the direction of the major axis 16 than in the direction of the minor axis 18. In Table III, eleven exemplary embodiments of the present invention are presented. The ratios of the spacing A between the major axis 16 and the spacing B between the minor axis 18 of each embodiment is listed. The ratio of dimension A to dimension B, varies from about 2:1 to 7:1. Furthermore, in the eleven examples presented, the length of the elongated apertures 14, that is, the distance X along the major axis 16 of the individual apertures 14 varies from 0.76 mm to 2.54 mm, whereas the width distance Y along the respective minor axes 16 of the apertures 14 varies from 0.38 mm to 0.76 mm. In the exemplary embodiments, the ratio of major axis 16 to minor axis 18 (X:Y) varies from about 2:1 to 5:1. Importantly, the wider separation along the major axes 16 provides an effectively greater film cross section in the direction of stretch S, and hence provides greater extendibility when the film 10 is stretched perpendicular to the major axis 16. In addition to the examples illustrating variously-sized openings and spacing between openings, the number of apertures 14 per unit area varies from slightly over 20/cm² to over 100/cm².

TABLE III

| | | | | | | | Approx. |
|---|---|---|---|---|---|---|---|
| | mm | | Ratio | mm | | Ratio | Holes |
| Example | X | Y | X:Y | A | B | A:B | per cm² |
| 1 | 0.76 | 0.51 | 3:2 | 0.63 | 0.32 | 2:1 | 103 |
| 2 | 0.76 | 0.38 | 2:1 | 0.63 | 0.32 | 2:1 | 86 |
| 3 | 0.76 | 0.38 | 2:1 | 0.76 | 0.38 | 2:1 | 87 |
| 4 | 1.02 | 0.51 | 2:1 | 0.76 | 0.25 | 3:1 | 75 |
| 5 | 1.02 | 0.51 | 2:1 | 0.51 | 0.38 | 4:3 | 75 |
| 6 | 1.02 | 0.51 | 2:1 | 0.76 | 0.25 | 3:1 | 75 |
| 7 | 1.27 | 0.63 | 2:1 | 0.76 | 0.25 | 3:1 | 56 |
| 8 | 2.03 | 0.51 | 4:1 | 2.29 | 0.33 | 7:1 | 28 |
| 9 | 2.29 | 0.76 | 3:1 | 1.52 | 0.38 | 4:1 | 23 |
| 10 | 2.54 | 0.51 | 5:1 | 1.78 | 0.33 | 5.4:1 | 28 |
| 11 | 2.03 | 0.51 | 4:1 | 1.27 | 0.33 | 4:1 | 36 |

In the above-described exemplary embodiments, the apertures 14 are elliptically shaped. However, it is easily seen that other patterns with respective long and short axes, where the long axes 16 is disposed perpendicular to the direction of stretch, will also be effective. For example, elongated hexagonal, octagonal, or rectangular aperture shapes would also provide an improvement in breathability when the film is stretched in a direction perpendicular to the orientation of the major axes 16.

In positioning the apertures 14 in the film 10, the elongated apertures 14 may be formed aligned rows and columns with the respective major axes 16 and minor axes 18 in respective common alignment. Alternatively, as shown in FIG. 3, the elongated apertures may be positioned in columns in which the minor axes 18 are aligned, but the major axes 16 are disposed in offset rows wherein the major axes 16 are offset from the aperture 14 in adjacently disposed columns. In a similar manner, as illustrated in FIG. 4, the elongated apertures 14 may be positioned in aligned rows wherein the major axes 16 are in respective alignment, but the minor axes 18 are offset.

Although the present invention is described in terms of a preferred exemplary embodiment, with additional illustrative embodiments, describing variously sized and shaped apertures 14 and aperture spacing and alignments, those skilled in the art will recognize that changes in those sizes, shapes, spacing, alignments and in the ratios of the major axes 16 to the minor axes 18, may be made without departing from the spirit of the invention. Such changes are intended to fall within the scope of the following claims. Other aspects, features and advantages of the present invention may be obtained from a study of this disclosure and the drawings, along with the appended claims.

What we claim is:

1. An apertured elastomeric film that is stretchable in a predefined direction, said film having a plurality of elongated apertures formed therethrough, each of said elongated apertures having a major axis extending along the length of a respective aperture and a minor axis transversely disposed with respect to the respective major axis, the major axis of each of said elongated apertures being orthogonally oriented with respect to said predefined direction of stretch.

2. An apertured elastomeric film, as set forth in claim 1, wherein the porosity of said film, as measured by the flow rate of air through said film per unit area, has a value when a 50% strain is applied to said film in said predefined direction of stretch that is at least 70% of the porosity of said film when in a relaxed state.

3. An apertured elastomeric film, as set forth in claim 1, wherein the ratio of the length of said major axis to the length of said minor axis of each of the apertures is from about 1.5:1 to about 5.0:1.

4. An apertured elastomeric film, as set forth in claim 3, wherein the ratio of the length of said major axis to the length of said minor axis of each of the apertures is about 3:1.

5. An apertured elastomeric film, as set forth in claim 1, wherein the spacing between said apertures, in a direction parallel to said major axes of the apertures, is less than the length of said major axes.

6. An apertured elastomeric film, as set forth in claim 1, wherein the spacing between said apertures, in a direction parallel to said minor axes of the apertures, is less than the length of said minor axes.

7. An apertured elastomeric film, as set forth in claim 1, wherein the spacing between said apertures in a direction parallel to said major axes of the apertures, is from about 1.5 to about 5 times the spacing between said apertures in a direction parallel to said minor axes.

8. An apertured elastomeric film that is stretchable in a predefined direction and has a plurality of elongated apertures formed therethrough, has a porosity of said film, as measured by the flow rate of air through said film per unit area, when a 50% strain is applied to said film in said predefined direction of stretch being at least 70% of the porosity of said film when in a relaxed state.

9. An apertured elastomeric film, as set forth in claim 8, wherein each of said elongated apertures has a major axis extending along the length of a respective aperture and a minor axis transversely disposed with respect to the respective major axis, the major axis of each of said elongated apertures being orthogonally oriented with respect to said predefined direction of stretch.

10. An apertured elastomeric film, as set forth in claim 8, wherein the ratio of the length of said major axis to the length of said minor axis of each of the apertures is from about 1.5:1 to about 5.0:1.

11. An apertured elastomeric film, as set forth in claim 10, wherein the ratio of the length of said major axis to the length of said minor axis of each of the apertures is about 3:1.

12. An apertured elastomeric film, as set forth in claim 8, wherein the spacing between said apertures, in a direction parallel to said major axes of the apertures, is less than the length of said major axes.

13. An apertured elastomeric film, as set forth in claim 8, wherein the spacing between said apertures, in a direction parallel to said minor axes of the apertures, is less than the length of said minor axes.

14. An apertured elastomeric film, as set forth in claim 8, wherein the spacing between said apertures in a direction parallel to said major axes of the apertures, is from about 1.5 to about 5 times the spacing between said apertures in a direction parallel to said minor axes.
